(19) United States
(12) Patent Application Publication
(10) Pub. No.: US 2026/0167785 A1
(43) Pub. Date: Jun. 18, 2026

(54) BIODEGRADABLE AND/OR COMPOSTABLE ALGAE BIOPOLYMER, CANNABIS, AND HEMP-BASED COMPOSITIONS AND METHODS OF USING THE SAME

(71) Applicant: Emily Gordin, Marlboro, NJ (US)

(72) Inventor: Emily Gordin, Marlboro, NJ (US)

(21) Appl. No.: 19/419,300

(22) Filed: Dec. 15, 2025

Related U.S. Application Data
(60) Provisional application No. 63/735,659, filed on Dec. 18, 2024.

(51) Int. Cl. C08J 5/04; C08J 3/12; C08J 5/18

(52) U.S. Cl. CPC C08J 5/045; C08J 3/12; C08J 5/18; C08J 2305/04; C08J 2401/02; C08J 2497/02

(57) ABSTRACT

The invention is a biodegradable and compostable material comprising a mixture of waste cannabis or hemp biomass and an algae-derived gel. Fibers from cannabis or hemp sources, including pulp, stalk, hurd, or flower trim, are combined with an algae-derived binder such as sodium alginate to form homogeneous composites that can be processed into flexible films, rigid boards, and three-dimensional molded articles. The compositions utilize low-value agricultural byproducts and naturally occurring polysaccharide binders to create structurally robust bioplastic materials. Because the components are inherently biodegradable, the resulting articles are expected to decompose under industrial or home composting conditions without generating persistent microplastics.

### CROSS REFERENCE TO RELATED APPLICATIONS

This application claims the benefit of U.S. Provisional Ser. No. 63/735,659, filed Dec. 18, 2024, the entire contents of which are incorporated by reference herein.

### FIELD OF THE INVENTION

The presently disclosed subject matter relates to compostable and/or biodegradable algae-derived biopolymer (e.g., seaweed) and cannabis and/or hemp-based compositions. The presently disclosed subject matter further includes methods of making and using the disclosed compositions to create biopolymer-based material composites.

### BACKGROUND OF THE INVENTION

Annually, millions of tons of polymer-based materials are produced and ultimately discarded in landfills as non-degradable wastes. The vast majority of polymers are derived from fossil fuel hydrocarbons, such as ethylene and propylene, and therefore are not biodegradable or compostable. When dispersed in the environment, known plastic materials have an average lifespan of 100-1000 years. Only destructive thermal treatment (such as combustion or pyrolysis) can permanently eliminate plastic waste. However, plastic waste management through incineration is associated with negative impacts, such as the release of greenhouse gases into the atmosphere. In addition, plastic materials require production cycles involving toxic substances, further contributing to environmental harm.

In response, polymers derived from natural resources (e.g., algae, fungi, corn, soy, wood, straw, flax, peas, and cotton) have been increasingly used to create a wide range of materials, such as plastics, adhesives, resins, textiles (e.g., woven and non-woven such as vegan leathers), and performance additives. However, many biomass-based materials are blended with traditional fossil fuel-derived adhesives or polymers, rendering the resultant products not fully biodegradable and/or compostable. Further, crops such as corn and soy are traditionally grown using intensive agricultural practices that include monocropping that depletes soil nutrients and accelerates land degradation. These practices, combined with deforestation required for agricultural expansion, exacerbate environmental impact.

Engineered wood compositions have emerged as an alternative to virgin wood. However, they are typically constructed from wood particles bonded with fossil fuel-derived adhesives. The adhesives (such as pMDI (polymeric methylene diphenyl diisocyanate), MDI (methylene diphenyl diisocyanate), and urea-formaldehyde) contribute to show or incomplete degradation of the composite material. Engineered wood products also emit volatile organic compounds (VOCs), contributing to indoor air pollution and adverse health effects. As demand for engineered wood increases, so does pressure on natural ecosystems, along with challenges associated with production, use, and disposal of fossil-derived adhesive systems.

It would therefore be beneficial to provide biodegradable and/or compostable materials that overcome the shortcomings of conventional polymer systems and engineered wood composites.

### SUMMARY OF THE INVENTION

In some embodiments, the presently disclosed subject matter is directed to a biodegradable and/or compostable composite composition comprising a mixture of about 50-95 weight percent (dry solids basis) cannabis or hemp biomass, based on the total weight of the composition and about 5-50 weight percent (dry solids basis) binder comprising sodium alginate and vegetable glycerin. The biomass is selected from beaten pulp, shredded stalks, hurd, flower trim, or combinations thereof. The composition is selectively formable into flexible films, rigid boards, and three-dimensional molded articles without petroleum-based products. The dry solids basis is the weight percentage of a component calculated after removal of substantially all free moisture from the material.

As used herein, the term “cannabis” refers to plants of the genus Cannabis, including Cannabis sativa L., Cannabis indica, Cannabis ruderalis, and hybrids or varieties thereof. The term encompasses all structural plant components, including stalks, stems, fibers, hurds, leaves, flowers, trim, and processed or unprocessed biomass, whether fresh, dried, post-harvest, or post-extraction.

As used herein, the term “hemp” refers to cannabis plant material derived from Cannabis sativa L. containing not more than 0.3% delta-9 tetrahydrocannabinol (THC) on a dry-weight basis, including all associated plant fractions such as stalks, bast fibers, hurds, leaves, roots, and flower trim, as well as mechanically or chemically processed derivatives thereof.

Binders include one or more components that promote adhesion, cohesion, plasticization, or structural integration of the biomass within the composite material. In the present disclosure, the binder comprises sodium alginate and vegetable glycerin, which cooperate to form a cohesive network that binds biomass particles and enables flexible film formation, rigid composite formation, and three-dimensional molding.”

Sodium alginate is the sodium salt of alginic acid, a naturally occurring polysaccharide extracted from brown seaweed and composed of beta-D-mannuronic acid and α-L-guluronic acid residues. Sodium alginate functions as a gelling, thickening, and ionic cross-linkable polymer within the disclosed binder system. In some embodiments, the sodium alginate is food-grade sodium alginate meeting standards for purity suitable for food processing, cosmetic, or pharmaceutical applications.

As used herein, the term “vegetable glycerin” refers to glycerol derived from plant-based oils, including but not limited to coconut oil, soybean oil, palm oil, rapeseed oil, or other triglyceride sources. Vegetable glycerin functions as a plasticizer within the binder system, imparting flexibility, processability, and moisture-retention characteristics to the resulting composite material.

In some embodiments, the biomass is obtained from post-harvest cannabis waste, post-extraction cannabis waste, industrial hemp waste, or combinations thereof. As used herein, the term “biomass” refers to organic material derived from plant matter, including structural, fibrous, and cellular components produced through biological growth. In the context of the present disclosure, biomass includes cannabis and hemp plant material and fragments thereof, including stalks, stems, fibers, hurds, leaves, flowers, trim, and pulped or shredded fractions, whether fresh, dried, processed, post-harvest waste, or post-extraction waste. The biomass serves as a lignocellulosic reinforcement component within the disclosed composite compositions.

As used herein, post-harvest cannabis waste refers to plant material remaining after the harvesting, trimming, cutting, drying, curing, or other primary processing of cannabis or hemp plants. The waste may include stalks, stems, fan leaves, sugar leaves, flower trim, roots, and other non-usable or non-marketable portions generated during routine cultivation and harvest operations.

Post-extraction cannabis waste refers to residual solid plant material remaining after cannabinoids, oils, or other constituents have been removed from cannabis or hemp biomass using solvent-based, mechanical, supercritical carbon dioxide, or other extraction processes. Post-extraction waste typically includes spent stalks, fibers, hurds, flower remnants, and other lignocellulosic solids depleted of extractable chemical constituents.

Industrial hemp waste refers to residual plant material generated during the cultivation, harvesting, processing, or fiber separation of hemp plants (Cannabis sativa L. containing not more than 0.3% THC on a dry-weight basis). Industrial hemp waste may include hurds, shredded stalks, outer bast fiber remnants, leaves, roots, and other by-products from fiber production, hurd milling, decortication, seed harvesting, or agricultural handling.”

In some embodiments, the biomass is derived from Cannabis sativa L. Cannabis sativa L. is an annual herbaceous flowering plant species of the Cannabaceae family that is widely cultivated for industrial, agricultural, medicinal, and fiber-producing purposes. The species is characterized by rapid growth, high biomass yield, and a fibrous stalk structure comprising an outer bast fiber layer and an inner woody core (hurd). Cannabis sativa L. includes both industrial hemp varieties containing no more than 0.3% delta-9 tetrahydrocannabinol (THC) on a dry-weight basis, as well as higher-THC cultivars grown for regulated cannabinoid production. The plant produces a variety of usable biomass components, including stalks, stems, leaves, flowers, and trim, all of which may serve as sources of lignocellulosic material for use in the composite compositions disclosed herein.

In some embodiments, the biomass comprises a mixture of two or more biomass types selected from beaten pulp, shredded stalk, hurd, and flower trim in predetermined ratios to tune flexibility or rigidity of the final article. “Beaten pulp” refers to mechanically processed cannabis or hemp biomass (typically derived from stalks, stems, or other fibrous plant portions) that has been hydrated and subjected to mechanical refining, beating, or fibrillation to separate and soften cellulose fibers and increase fiber surface area for improved bonding within the composite. The term “shredded stalk” refers to cannabis or hemp stalk material that has been mechanically chopped, cut, milled, or shredded into elongated or irregular fibrous fragments while substantially retaining the native lignocellulosic structure of the stalk. The term “flower trim” refers to the residual floral and leafy biomass remaining after harvesting and trimming of cannabis or hemp flowers for cannabinoid extraction or processing, including calyx material, sugar leaves, and associated plant fragments. The term “hurd” refers to the woody inner core of the cannabis or hemp stalk remaining after removal of outer bast fibers.

In some embodiments, the sodium alginate is food-grade sodium alginate. Food-grade sodium alginate is sodium alginate that meets recognized purity and safety standards for use in food and ingestible products, as opposed to industrial-grade alginate (which may contain higher heavy metals, insoluble impurities, or residual solvents). Thus, food-grade sodium alginate is safe for human consumption under regulatory standards, including those set forth by the U.S. Food and Drug Administration as Generally Recognized as Safe (GRAS) under 21 CFR § 184.1724, the Food Chemicals Codex (FCC), the United States Pharmacopeia (USP), and/or equivalent international standards such as FAO/WHO specifications.

In some embodiments, the sodium alginate and vegetable glycerin function as a dual-component plasticizing and ionic cross-linkable binder system. Thus, the binder system comprises (i) sodium alginate that provides ionic cross-linking capability in the presence of divalent cations such as calcium ions to form a structurally reinforcing polymer network, and (ii) vegetable glycerin that functions as a plasticizer to impart flexibility, reduce brittleness, and modify the mechanical properties of the formed composite. The combined action of the alginate and glycerin enables the composite to be selectively formed into either flexible or rigid articles depending on formulation and processing conditions.

In some embodiments, the presently disclosed subject matter is directed to a flexible biodegradable film formed from the disclosed composition. A flexible biodegradable film refers to a thin sheet of material formed from the disclosed biomass-alginate composition that is capable of bending, folding, or deforming without cracking or breaking under normal handling conditions, and that is composed entirely of materials that are known to undergo biological degradation in soil or compost environments. Flexible biodegradable films prepared according to the present disclosure are typically formed by casting, spreading, rolling, or molding the aqueous biomass-alginate mixture into a thin layer and drying the layer to produce a pliable, self-supporting sheet. In some embodiments, a flexible film has flexural modulus of less than 300 MPa (megapascal).

In some embodiments, the presently disclosed subject matter is directed to a rigid composite board formed from the disclosed composition. As used herein, “rigid composite board” refers to a self-supporting, planar structural article formed from the disclosed biomass-alginate composition that, after drying or curing, exhibits sufficient stiffness and dimensional stability to maintain its shape under its own weight and under normal handling and use without substantial bending or deformation. In some embodiments, a rigid composite board can have a flexural modulus (ASTM D790) of greater than 500 MPa.

In some embodiments, the presently disclosed subject matter is directed to a three-dimensional molded article formed from the disclosed composition. A three-dimensional molded article is a formed object having a non-planar geometry with thickness, depth, and volume in three orthogonal dimensions, produced by shaping the disclosed composition within a mold so that the article retains its three-dimensional shape after drying or curing.

In some embodiments, the article is formed by slip-casting the composition into a calcium-containing mold to induce ionic cross-linking of the sodium alginate. Slip casting is a forming process in which the disclosed biomass-alginate composition (in a flowable slurry or suspension form) is poured into a porous calcium-containing mold so that liquid is absorbed into the mold and calcium ions are released at the mold interface. As a result, ionic cross-linking of the sodium alginate is induced and formation of a solidified skin layer that defines the shape of the molded article is produced.

In some embodiments, the calcium-containing mold includes calcium-bearing mineral materials such as calcium carbonate or calcium sulfate (e.g., plaster of Paris). These materials typically include about 20-40% by weight calcium, which is present as calcium (+2) ions bound in the mineral matrix. Upon contact with the aqueous biomass-alginate mixture, a portion of the calcium ions becomes available at the mold surface to trigger ionic cross-linking of sodium alginate. “Ionic cross-linking” refers to the formation of reversible or semi-permanent intermolecular bonds between polymer chains through electrostatic interactions with multivalent ions. In the present disclosure, ionic cross-linking occurs when divalent calcium ions interact with carboxylate groups of sodium alginate to form an ionically bonded network that increases the mechanical strength, water resistance, and structural integrity of the formed article.

In some embodiments, the calcium-containing mold comprises calcium carbonate plaster. For purposes of the present disclosure, calcium carbonate plaster includes any calcium-containing plaster or castable mold material that comprises calcium carbonate and that when contacted with an alginate-containing composition supplies divalent calcium ions at the mold interface sufficient to induce ionic cross-linking of the alginate. Chemically, calcium carbonate plaster comprises a hardened mineral matrix that includes calcium carbonate (CaCO₃) as a primary calcium source and, in some embodiments, calcium sulfate and other inorganic setting agents, wherein the material is capable of releasing divalent calcium ions at its surface upon contact with an alginate-containing composition.

In some embodiments, the composition includes about 1-25 weight percent water during processing (e.g., at least/no more than about 1, 2, 3, 4, 5, 6, 7, 8, 9, 10, 11, 12, 13, 14, 15, 16, 17, 18, 19, 20, 21, 22, 23, 24, or 25 weight percent, based on the total weight of the composition). The phrase “during processing” refers to the presence of water while the biomass, alginate, and glycerin are being mixed, blended, shaped, cast, molded, or otherwise formed into an article. The water functions as a temporary processing aid and is partially or fully removed during subsequent drying or dehydration steps. Accordingly, the recited water content does not imply that the finished, dried composite article contains the same amount of water

In some embodiments, the flexible film has a thickness of about 0.05-5 mm (e.g., at least/no more than about 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.25, 1.5, 1.75, 2, 2.25, 2.5, 2.75, 3, 3.25, 3.5, 3.75, 4, 4.25, 4.5, 4.75, or 5 mm). “Thickness” refers to the perpendicular distance between the first major surface and the opposing second major surface of the flexible film.

In some embodiments, the composition is substantially free of petrochemical-derived polymer resins. As used herein, the term “substantially free” means that the composition contains no intentionally added or added petrochemical-derived polymer resins and (if present at all) the materials exist only in trace or incidental amounts that do not materially affect the biodegradable or compostable nature of the composition. In some embodiments, “substantially free” means less than about 1 weight percent, less than about 0.5 weight percent, or less than about 0.1 weight percent of petrochemical-derived polymer resins, based on the total weight of the composition. As used herein, the term “petrochemical-derived polymer resins” refers to synthetic polymer materials produced wholly or primarily from fossil-fuel-derived hydrocarbons, including (but not limited to) petroleum, natural gas, or coal. Non-limiting examples include polyethylene, polypropylene, polystyrene, polyvinyl chloride (PVC), polyethylene terephthalate (PET), polyurethane, epoxy resins, acrylic resins, and styrenic polymers.

In some embodiments, the resulting article exhibits mechanical strength suitable for packaging, textile, or construction applications. For example, in some non-limiting embodiments, the resulting article exhibits a tensile strength of at least about 1-50 MPa as measured in accordance with ASTM D638 or ASTM D882, a flexural strength of at least about 5-100 MPa as measured in accordance with ASTM D790, and/or a flexural modulus of at least about 100-5,000 MPa as measured in accordance with ASTM D790.

In some embodiments, the composition is capable of biodegrading under aerobic soil or compost conditions without generating persistent microplastics. “Capable of biodegrading” means that the material is composed of constituents that undergo chemical and/or biological breakdown through the action of naturally occurring microorganisms, moisture, oxygen, and environmental conditions to yield smaller molecular components, inorganic substances, and/or biomass over time (e.g., carbon dioxide, water, inorganic compounds, and biomass). The phrase does not require a specific degradation rate.

Aerobic soil or compost conditions include environmental conditions in which oxygen is present and available to support microbial activity responsible for biological degradation. The conditions typically occur in naturally oxygenated soil environments and in managed composting systems where temperature, moisture, and oxygen levels support the metabolic activity of bacteria, fungi, and other microorganisms capable of decomposing organic materials.

Microplastics are small plastic particles having a characteristic dimension of less than about 5 millimeters that originate from the fragmentation, breakdown, or incomplete degradation of larger plastic materials and which persist in the environment. Persistent microplastics are microplastic particles that resist further biological, chemical, or environmental degradation and remain in soil, water, or living organisms for extended periods of time without being mineralized into naturally occurring molecular constituents. Thus, the absence of persistent microplastics means that the disclosed compositions degrade into naturally occurring molecular components and biomass without leaving behind synthetic polymer fragments that persist in the environment.

In some embodiments, the article is used in packaging, fashion textiles, display materials, construction panels, or decorative objects. Non-limiting examples of packaging articles include flexible wrapping films, pouches, trays, blister-style containers, molded protective inserts, cushioning materials, and disposable food or consumer-goods packaging. Fashion textile applications may include coated fabrics, vegan leather alternatives, wearable sheets, garment panels, trims, accessories, handbags, footwear components, and textile-backed composite films. Display materials may include point-of-sale signage, retail display panels, merchandising fixtures, exhibition components, decorative backdrops, and temporary architectural displays. Construction panels may include interior wall panels, ceiling tiles, insulation boards, acoustic panels, non-load-bearing wall systems, cabinetry panels, and composite sheathing. Decorative objects may include molded vessels, planters, bowls, lighting components, frames, sculptural forms, home décor items, ornaments, and artistic installations.

In some embodiments, the presently disclosed subject matter is a method of forming a biodegradable composite article. The method includes combining cannabis or hemp biomass with sodium alginate, vegetable glycerin, and water to form a mixture. The method also includes shaping the mixture into a mold and drying the mixture to form a flexible or rigid article. Shaping the mixture into a mold can include introducing the mixture into, onto, or against a mold surface to impart a desired two-dimensional or three-dimensional geometry to the composition. Shaping may be performed by pouring, casting, slip-casting, pressing, compression molding, rolling, extrusion into a mold cavity, spraying, or any combination thereof. The mold may define a planar film geometry, a rigid board geometry, or a three-dimensional article geometry, and may be constructed from plaster, metal, ceramic, silicone, polymeric materials, wood, carbon fiber, or combinations thereof.

The drying step includes removal of at least a portion of the water from the shaped mixture by evaporation, dehydration, or curing to convert the flowable or deformable mixture into a self-supporting solid article. Drying may be carried out under ambient conditions, forced air circulation, elevated temperature, reduced pressure, or combinations thereof. The drying step may be continued until the article reaches a desired mechanical strength, dimensional stability, and residual moisture content suitable for its intended end use.

In some embodiments, the shaping step comprises slip-casting the mixture into a calcium-containing mold.

In some embodiments, the method includes mechanically reducing the biomass to particle sizes (e.g., the largest characteristic external dimension of an individual fragment of mechanically processed biomass, including fiber length, fragment length, or equivalent spherical diameter for irregularly shaped particles) between about 0.02 mm and 127 mm prior to mixing (e.g., at least/no more than about 0.02, 0.5, 1, 5, 10, 20, 30, 40, 50, 60, 70, 80, 90, 100, 110, 120, 127 mm).

In some embodiments, the presently disclosed subject matter is directed to composite materials consisting essentially of about 50-95 weight percent, on a dry solids basis, biomass derived from Cannabis sativa L., selected from beaten pulp, shredded stalk, hurd, flower trim, or combinations thereof, wherein the biomass is obtained as post-harvest waste, post-extraction waste, or as fresh or processed material from purpose-grown industrial hemp, and about 5-50 weight percent, on a dry solids basis, of a binder comprising sodium alginate and vegetable glycerin. Depending on the quality and form of the Cannabis sativa L. biomass in combination with the alginate-based binder, the composite material can be formed into flexible films, rigid boards, and three-dimensional articles having either rigid or flexible mechanical properties.

### BRIEF DESCRIPTION OF THE DRAWINGS

FIG. 1a is a front plan view of a cannabis plant in accordance with some embodiments of the presently disclosed subject matter.

FIG. 1b is a front plan view of a cannabis plant leaves and flower in accordance with some embodiments of the presently disclosed subject matter.

FIG. 1c is a cross-sectional view of a hemp fiber in accordance with some embodiments of the presently disclosed subject matter.

FIG. 2 is a schematic illustrating combining biomass and algae derived gel to create a mixture in accordance with some embodiments of the presently disclosed subject matter.

### DETAILED DESCRIPTION OF THE INVENTION

For the purpose of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “an element” means at least one element and can include more than one element. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods. Thus, the term “about” is used to provide flexibility to a numerical range endpoint by providing that a given value may be “slightly above” or “slightly below” the endpoint without affecting the desired result.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

All methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. No language in the specification should be construed as indicating any unclaimed element as essential to the practice of the invention.

Unless otherwise defined, all technical terms used herein have the same meaning as commonly understood by one of ordinary skill in the art to which this disclosure belongs.

The presently disclosed subject matter is directed to novel biodegradable and/or compostable materials constructed from waste cannabis biomass and algae-derived gels. Specifically, fibers from cannabis and hemp biomass are combined with an algae-derived polymer (such as an alginate) to form a compound that has wide industrial applications. Advantageously, the presently disclosed subject matter includes the use of low-quality cellulose fibers found in cannabis biomass that lacks textile value as raw material to prepare polymer composite products. Further, the disclosed compositions are both biodegradable and compostable and do not adversely affect the environment.

As noted above, the disclosed compositions comprise cannabis and hemp biomass. The term “cannabis” refers to a genus of flowering plants in the Cannabaceae family. Plants of the genus Cannabis include several species, including Cannabis sativa, Cannabis indica, and Cannabis ruderalis. There is a long history of cultivating plants of genus Cannabis for hemp fibers, seeds and seed oils, medicinal purposes, and recreational activities. The disclosed Cannabis biomass material can include C. sativa, C. indica, C. ruderalis, or combinations thereof.

Cannabis Sativa is an annual herbaceous flowering plant that includes the psychoactive constituent tetrahydrocannabinol (THC). However, C. sativa includes more than 500 compounds (of which 113 are cannabinoids). Some C. sativa plants produce cannabidiol (CBD) in high concentrations. CBD is not psychoactive but has been shown to block the effect of THC in the nervous system.

Cannabis Indica is an annual plant species in the family Cannabaceae. The plant produces large amounts of THC and tetrahydrocannabivarin (THCV), with total cannabinoid levels being as high as 53.7%.

Cannabis Ruderalis is a variety, subspecies, or species of Cannabis native to Central and Eastern Europe and Russia. It contains a relatively low quantity of THC and does not require photoperiod to blossom (unlike C. indica and C. sativa). However, C. ruderalis is often high in CBD.

The term “cannabis plant” or “cannabis biomass” as used herein therefore refers to one or more components from one or more of C. sativa, C. indica, or C. ruderalis plants. As used herein, the term “biomass” refers to any organic material produced from the Cannabis plant. The term “waste biomass” refers to any organic waste from the Cannabis plant or portions thereof generated throughout harvesting, drying, curing, pruning, trimming, cloning, propagation, and other processing to produce an isolate or concentrate (e.g., flowers, leaves, stalks, roots, trim and solid plant material). Waste biomass also includes laboratory plant waste (e.g., goods/product samples or specimens remaining after laboratory testing).

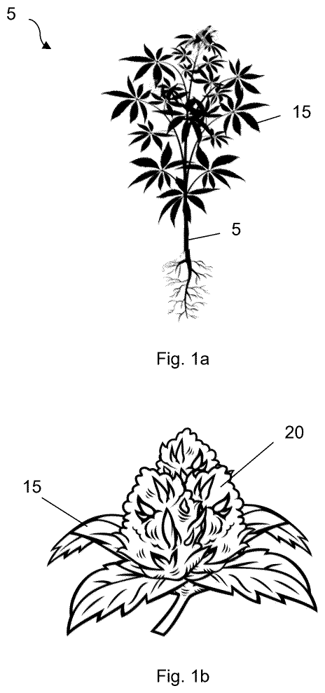

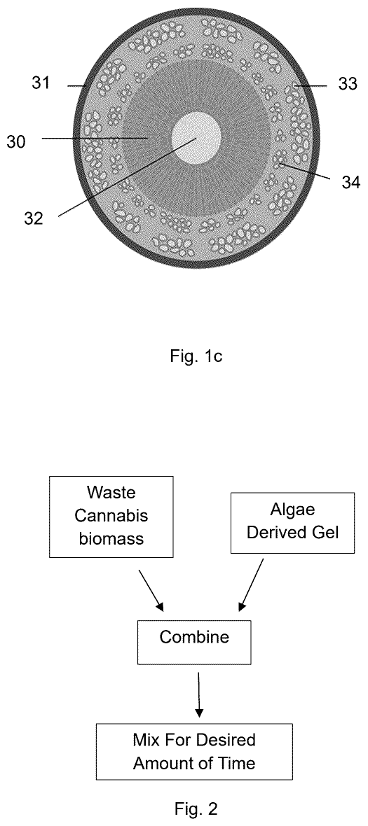

In some embodiments, the waste cannabis biomass material includes any portion(s) of the Cannabis plant, such as the stalk, stem, leaves, and/or flower. As illustrated in FIGS. 1a and 1b, the term “stem” refers to an elongated structure of the plant to which other plant portions are connected. Stem 10 of Cannabis plant 5 supports leaves 15 and flowers 20, transports water and dissolved substances between roots 25 and the leaves, and stores nutrients. The Cannabis stem or stalk also gives the plant structure and stability.

The term “leaf” refers to an organ of a vascular plant, as defined in botanical terms, and in particular, in plant morphology. In reference to Cannabis, the first pair of leaves usually have a single leaflet, the number gradually increasing up to a maximum of about thirteen leaflets per leaf (usually seven or nine), depending on variety and growing conditions. At the top of a flowering plant, this number again diminishes to a single leaflet per leaf, as shown in FIG. 1a. The lower leaf pairs usually occur in an opposite leaf arrangement and the upper leaf pairs in an alternate arrangement on the main stem of a mature plant.

The term “flower” (also known as “buds”) refers to the characteristic reproductive structure of the plant and includes the whole flower or a portion thereof, as shown in FIG. 1b.

In some embodiments, the materials include hemp. The term “hemp” refers to cannabis that contains 0.3% or less THC by dry weight. The CBD-rich hemp extract may be prepared by any method known in the art. Hemp is one of the fastest growing crops in the world, fully maturing after four months. The hemp plant can be manipulated in a variety of different ways, having the potential to become over 25,000 different products ranging from medicines to industrial building materials. The hemp stalk is made of two different quality hemp materials: fiber and hurd. The term “hurd” refers to the woody inner core of the hemp plant. As shown in FIG. 1c, the hemp fiber includes the outer epidermis layer 31, hurd 30, and hollow inner core 32. The hemp fiber also includes primary and secondary bast fiber bundles 33 and 34. Hemp hurds 30 are often used in textiles, bioethanol production, mulching, production of hempcrete, compost, and animal bedding. Hemp fiber is the outer layer of the hemp stalk and has been traditionally used to make fiber, rope, sails, paper, flooring, paper, and insulation.

The hemp and cannabis materials can be processed in a variety of ways. For example, the plant materials can be processed into fiber, shredded stalk, pulped fiber, or whole biomass. Conventional methods of processing can be used. For example, kraft (conventional pulping processes) and/or shredding with conventional equipment such as a Hammer Mill (or any dual shafter shredder machine) can be used.

The disclosed compositions can comprise about 50-95 weight percent biomass. Thus, the compositions can comprise at least about (or no more than about) 50, 55, 60, 65, 70, 75, 80, 85, 90, or 95 weight percent waste biomass, based on the total weight of the composition.

As described above, the processed cannabis plant materials are combined with algae derived polymers. Algae are photosynthetic organisms that are a virtually inexhaustible resource due to their diversity, growth rate, and photosynthetic nature. The term “gel” refers to a wet three-dimensional porous network. For example, a gel network spans the volume of a liquid medium and ensnares it through surface tension effects. The internal network structure of a gel may result from physical bonds, chemical bonds, crystallites, or other junctions that remain intact within the extending fluid. It is the cross-linking within the fluid that gives a gel its structure (hardness) and contributes to the adhesive tack. In this way, gels are a dispersion of molecules of a liquid within a solid medium.

In some embodiments, the algae-derived gel can be an alginate. Alginate is a polysaccharide characterized by the repetition of D-mannuronic acid and L-guluronic acid units. Alginates exist widely in brown seaweeds, such as species of ascophyllum, durvillaea, ecklonia, laminaria, lessonia, macrocystis, sargassum, and turbinaria. Alginates therefore have a high thickening and gelling power.

The alginate can be sodium alginate in some embodiments. Sodium alginate is the sodium salt of alginic acid and has the chemical formula NaC₆H₇O₆. Sodium alginate is a natural polysaccharide found in brown algae. It should be appreciated that the algae-derived gel can include sodium alginate and/or potassium alginate, magnesium alginate, ammonium alginate, and the like.

However, in some embodiments, the algae-derived gel comprises sodium alginate and/or agar. Other algae-derived or biodegradable polymers such as chitin, carrageenan, carboxymethyl cellulose (CMC), sodium CMC, microfibrillated cellulose (MFC), polyhydroxyalkanoate (PHA), polyhydroxybutyrate (PHB), polylactic acid (PLA), polybutylene adipate terephthalate (PBAT), or combinations thereof are contemplated as optional alternative binders or co-binders in additional embodiments.

Agar is a jelly-like product that includes polysaccharide polymer obtained from the cell walls of some species of red algae (primarily from Gracilaria and Gelidiaceae species). As found in nature, agar is a mixture of two components, the linear polysaccharide agarose and a heterogeneous mixture of smaller agaropectin molecules. Agar forms the supporting structure in the cell walls of certain species of algae and is released upon boiling.

Chitin is a long-chain polymer of N-acetylglucosamine, an amide derivative of glucose. Chitin is the second most abundant polysaccharide in nature (behind only cellulose). It is a primary component of cell walls in fungi (especially filamentous and mushroom forming fungi), the exoskeletons of arthropods such as crustaceans and insects, the radulae, cephalopod beaks and gladii of mollusks, and in some nematodes and diatoms.

Carrageenan is a family of natural linear sulfated polysaccharides polymer extracted from red edible seaweeds. Carrageenans are widely used in the food industry for their gelling, thickening, and stabilizing properties. Carrageenans contain 15-40% ester-sulfate content, making them anionic polysaccharides. A common seaweed used for manufacturing the hydrophilic colloids to produce carrageenan is Chondrus crispus (Irish moss), which is a dark red, parsley-like alga that grows attached to rocks.

CMC is a cellulose derivative polymer that includes carboxymethyl groups (—CH₂—COOH) bound to some of the hydroxyl groups of the glucopyranose monomers that make up the cellulose backbone. It is often used in its sodium salt form, sodium carboxymethyl cellulose.

MFC refers to the entangled fibrils produced through a fibrillation process. Specifically, cellulose fibers are separated into a three dimensional network of microfibrils with a large surface area. MFC can be produced by soaking and dispersing pulp in water, and then separating the cellulose fibers using high shear forces into microfibrils.

PHA is a class of polyesters produced in nature by numerous microorganisms, such as by the bacterial fermentation of sugars or lipids. When produced by bacteria, PHAs serve as both a source of energy and as a carbon store. PLAs are biodegradable and are used in the production of bioplastics.

PHB is a polyhydroxyalkanoate (PHA), a polymer belonging to the polyesters class that are of interest as bio-derived and biodegradable plastics. PHB is produced by microorganisms (such as Cupriavidus necator, Methylobacterium rhodesianum, or Bacillus megaterium) in response to conditions of physiological stress. PHB is primarily a product of carbon assimilation (from glucose or starch) and is employed by microorganisms as a form of energy storage molecule to be metabolized when other common energy sources are not available.

PLA is a thermoplastic polyester (or polyhydroxyalkanoate) with backbone formula (C₃H₄O₂)n or [—C(CH₃)HC(═O)O-]n, obtained by the condensation of lactic acid with a loss of water. The monomer is typically produced from fermented plant starch such as from corn, cassava, sugarcane, or sugar beet pulp.

PBAT is a biodegradable random copolymer of adipic acid, 1,4-butanediol, and terephthalic acid. PBAT is generally considered a fully biodegradable alternative to low-density polyethylene, having many similar properties including flexibility and resilience, allowing it to be used for many similar uses such as plastic bags and wraps. The structure of PBAT is a random-block polymer comprising butanediol-adipic acid and butanediol-terephthalic acid blocks.

The disclosed compositions can comprise about 5-50 weight percent polymer (e.g., algae derived polymer). Thus, the compositions can comprise at least about (or no more than about) 5, 10, 15, 20, 25, 30, 35, 40, 45, or 50, weight percent gel, based on the total weight of the composition.

In certain embodiments, the disclosed composite materials consist essentially of about 50-95 weight percent biomass derived from Cannabis sativa L., selected from beaten pulp, shredded stalk, hurd, flower trim, or combinations thereof, and about 5-50 weight percent binder comprising sodium alginate and vegetable glycerin, based on a dry solids basis. Depending on the quality and form of the Cannabis sativa L. biomass used in combination with the alginate binder system, the resulting composite can be selectively formed into flexible films, rigid boards, and three-dimensional articles having rigid or flexible mechanical properties.

Because all components are known to be fully biodegradable in soil and compost environments, the resulting articles are expected to be fully biodegradable and compostable in industrial facilities in accordance with ASTM D6400 and home-composting conditions. All components are food-grade or GRAS and individually certified or demonstrated to biodegrade fully in aerobic environments. The resulting composites contain no synthetic additives that inhibit biodegradation, are inherently biodegradable in soil, and are expected to meet industrial compostability standards (ASTM D6400/EN 13432, incorporated by reference herein) without producing microplastics or toxic residues, pending formal certification.

Formal industrial compostability certification testing under ASTM D6400 or EN 13432 has not yet been completed for all embodiments as of the filing date. However, based on the known biodegradation behavior of the individual constituent materials, the resulting composite articles are reasonably expected to meet such standards without generating microplastics or toxic residues.

As noted above, the disclosed compositions (and related products formed from the compositions) are biodegradable and compostable. “Biodegradable” refers to material that when exposed to an aerobic and/or anaerobic environment, ultimately results in the reduction to monomeric components due to microbial, hydrolytic, and/or chemical actions. Under aerobic conditions, biodegradation leads to the transformation of the material to end products such as carbon dioxide and water. Under anaerobic conditions, biodegradation leads to the transformation of the materials to carbon dioxide, water, and methane. Biodegradability means that all constituents of the disclosed products are subject to decomposition eventually through biological or any other natural activity (e.g., bacteria, rain). Thus, a biodegradable material or product is capable of being broken down (e.g. metabolized and/or hydrolyzed) by the action of naturally occurring microorganisms or processes, such as fungi, bacteria, weather, and/or plants. A biodegradable composition therefore naturally decomposes into harmless constituents in water or aqueous or moist environments, typically through the action of microorganisms such as bacteria or fungi.

In some embodiments, the disclosed compositions biodegrade within a timeframe of about 1 year or less. Thus, the disclosed compositions can be fully biodegraded in at least about (or no more than about) 12, 11, 10, 9, 8, 7, 6, 5, 4, 3, 2, or 1 months.

In some embodiments, the disclosed compositions (and products formed from the disclosed compositions) are about 100% biodegradable in accordance with ASTM D6400, incorporated by reference herein. In other embodiments, the disclosed compositions and associated products are about 90-99.99% biodegradable (e.g., at least/no more than about 90, 95, 99, 99.9, or 99.99% biodegradable).

The term “compostable” refers to a product or material that has the ability to be decomposed into organic matter over time. For example, compostable material is able to decompose in aerobic environments that are maintained under specific controlled temperature and humidity conditions. Compostable materials are therefore capable of undergoing biological decomposition in a compost site such that the material is not visually distinguishable and breaks down into carbon dioxide, water, inorganic compounds, and biomass at a rate consistent with known compostable materials. After being degraded, a compostable product is therefore broken down into nutrients which can be used to enrich the soil.

In some embodiments, the disclosed compositions (and products formed from the disclosed compositions) are about 100% compostable in accordance with ASTM D6464, incorporated by reference herein. In other embodiments, the disclosed compositions and associated products are about 90-99.99% compostable (e.g., at least/no more than about 90, 95, 99, 99.9, or 99.99% compostable).

In some embodiments, the disclosed compositions are degraded during compost conditions within a timeframe of about 1 year or less. Thus, the disclosed compositions can be fully composted in at least about (or no more than about) 12, 11, 10, 9, 8, 7, 6, 5, 4, 3, 2, or 1 months.

The hemp or cannabis process biomass and algae derived polymer materials as described above can be combined using any known method to create a mixture. For example, the two components can be stirred, blended, mixed, or kneaded to combine using standard equipment (e.g., industrial mixers and the like).

The waste biomass and the algae derived gel can be combined for a desired amount of time to create a fully integrated and uniformly dispersed mixture. For example, the mixing can occur for about 0.5-10 hours (e.g., at least/no more than about 0.5, 1, 2, 3, 4, 5, 6, 7, 8, 9, or 10 hours). Prior to combining, the biomass material may optionally be broken down, chemically and/or mechanically into small particle sizes/constitutions (e.g., of about 0.02-127 mm) using conventional methods (e.g., Kraft pulping, shredding, cutting, chopping, and the like) for a desired amount of time (e.g., 0.5-10 hours).

Once combined, the mixed compound can be used to form any suitable article. Representative articles can include (but are not limited to) flexible films, molded articles, and particle board.

The term “flexible film” refers to a thin sheet of flexible material that maintains its form without being supported on an associated substrate. Flexible films have the ability to change into a large variety of determinate and indeterminate shapes without damage thereto in response to the action of an applied force. To create flexible films, hemp pulp and algae polymer are combined as described above. About 1-25 weight percent water (based on the total weight of the mixture) can be added to the combined biomass and gel mixture. Any type of water can be used, such as (but not limited to) filtered water, distilled water, purified water, spring water, mineral water, tap water, or any combination thereof.

After combining, the mixture can be formed, poured, rolled, compressed, sprayed, extruded, or cast in a mold and dried or dehydrated to create a plastic-like material (e.g., bioplastic material). Molds can be constructed from wood, plastic, carbon fiber, ceramics, metal, linoleum, and/or plaster. Once dried, the resultant material is removed from the mold, thereby producing a flexible film. The molding may be performed at a temperature higher than 100° F. in some embodiments.

In some variations, the flexible films may be adhered to woven natural textile sheets (e.g., cotton, hemp, or flax blends) using biodegradable adhesives. In some embodiments, the solution/mixture can be cast on molds with embossed characteristics, giving the produced flexible films the embossed characteristics.

While not intending to be bound by any theory, the cannabis/hemp material advantageously creates a strong film or product due to the cellulose present in the pulp mixing with the algae polymer.

The disclosed film can have a thickness of about 0.05-5 mm (e.g., at least/no more than about 0.05, 0.1, 0.2, 0.3, 0.4, 0.5, 0.6, 0.7, 0.8, 0.9, 1, 2, 3, 4, or 5 mm).

The term “rigid film” refers to a film that is hard, stiff, and has little flexibility.

In some embodiments, the disclosed biomass and gel compositions can be used to form particle board and other 3D forms. Alternatively, the forming can be carried out by pressure molding, injection molding, or casting into a mold of a desired shape. These techniques make it possible to obtain bioplastic products of complex shapes and with suitable thicknesses to allow the maintenance of these shapes.

The produced articles can be used to construct a variety of products in a wide array of industries. For example, the disclosed compositions can be used to produce curtains, packaging, decals, alternative textiles, bioplastics, display paraphernalia, merchandising solutions, and decorative objects. All materials can be modified with pigment and surface finishes to advance performance or look.

The presently disclosed subject matter includes many advantages over the prior art. For example, the growing CBD and THC market has led to a massive supply of biomass waste that can be converted into a range of industrial materials when combined with the noted algae-derived gels.

Films and articles produced from the disclosed compositions can function as passive dehumidifiers by absorbing and releasing moisture.

The chemical and physical structure of the biomass advantageously produces films and articles with increased strength when compared to other bioplastic materials.

Algae are photosynthetic organisms that are a virtually inexhaustible resource due to their diversity, growth rate, and photosynthetic nature.

The disclosed films and articles can be formulated to replace petroleum-based plastics.

The films and articles produced from the disclosed compositions are safer for the consumer when compared to traditional plastic products.

The disclosed compositions are environmentally friendly and environmentally sustainable.

Films and articles produced from the noted compositions exhibit physical-mechanical properties comparable to those of conventional polymer based materials.

The disclosed compositions can be used in a variety of industries, such as fashion, packaging, and construction.

Advantageously, the bioplastic composition according to the invention is formed from materials that are inherently biodegradable and/or compostable based on their known material properties. The disclosed bioplastic compositions are expected to effectively compost, including under home composting conditions, without the need for specialized enzymes, chemical treatments, or elevated processing temperatures. Even if dispersed in the environment, the bioplastic compositions are expected to degrade naturally and be assimilated into the soil without generating persistent microplastics.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

### EXAMPLES

The following Examples provide illustrative embodiments of the presently disclosed subject matter. In light of the present disclosure and the general level of skill in the art, those of ordinary skill can appreciate that the following Examples are intended to be exemplary only and that numerous changes, modifications, and alterations can be employed without departing from the scope of the presently disclosed subject matter.

### Example 1

### Preparation of Flexible Films

10-60 (e.g., 50) grams of wet hemp pulp, 2-20 mL (e.g., 10 mL) glycerin, 500 mL water, and 5 grams alginate powder S500C were mixed together and blended into a mixture. Prior to mixing, the wet pulp was beaten for 1-8 hours to reduce particle size. The sodium alginate can range from 1-4 weight percent relative to the amount of water.

After combining, the mixture was poured, cast, rolled, or spread into a mold. The mold includes a flat nonstick surface (e.g., MOD, linoleum, plexiglass) from 0.79375 mm (0.03125 inches) to 12.7 mm (0.5 inches). The mixture was then cast and dehydrated to form a film. The material was cut out/peeled from the mold, resulting in a flexible sheet.

In some variations, flexible films may be adhered with biodegradable adhesives to woven natural textile sheets. The woven natural textile sheets can include cotton, hemp, and/or flax blends.

In further variations of Example 1, the following formulations were prepared to demonstrate the versatility of the biomass-alginate composite system:
(a) Flexible film from hemp pulp: 50 g beaten hemp pulp, 10 mL vegetable glycerin, 5 g sodium alginate, and 500 mL water were combined to produce a uniform mixture and cast into a flexible sheet.
(b) Flexible thin sheet from hemp hurd: 50 g shredded hurd, 12 mL glycerin, 6 g sodium alginate, and 520 mL water were blended to form a thin, pliable film after drying.
(c) Flexible film from dry cannabis flower trim: 10 g dry cannabis flower trim, 15 mL glycerin, 6 g sodium alginate, and 280 mL water were mixed and cast to form a flexible bioplastic film following dehydration.

### Example 2

### Preparation of Forms Using a Plaster Form

A mixture was prepared as in Example 1. Specifically, the mixture was poured into the plaster mold and rested, allowing the plaster to absorb the mixture, achieving a wall thickness of 0.79375 mm (0.03125 inches)- 3.175 mm (0.125 inches).

After 10-60 minutes, the mixture was poured from the mold. A portion of the mixture formed a skin/wall thickness and dried in the mold. Once dry, the layer was removed. A cross-linking reaction between the sodium in the sodium alginate and the calcium in the calcium carbonate in the plaster occurred, creating a water resistant layer/material.

Further slip-cast articles were produced using modified formulations to illustrate alternative biomass sources and ratios:
(a) Slip-cast vessel from hemp pulp: 110 g beaten pulp, 125 mL vegetable glycerin, 5 g sodium alginate, and 500 mL water were mixed and poured into a plaster mold, where the mixture rested for 30 minutes before excess material was removed.
(b) Slip-cast vessel from shredded stalk: 200 g shredded stalk, 180 mL glycerin, 10 g sodium alginate, and 550 mL water were blended and poured into a plaster mold, allowed to rest, and then dried to yield a rigid shaped article.

### Example 3

### Preparation of Rigid Composites

Cannabis Sativa stalks (ranging in height from 0.6 m-1.8 m/2 ft-6 ft) were collected and prepared using a dual motor shredder or a Hammermill. The shredded stalks (6 mm +/−) were combined with 10% alginate solution in 3:1 hemp: alginate ratio.

To prepare a rigid board of the size 12×12×0.25 inches (144 in²) 500 grams of hemp hurd, 1,500 grams of 10% alginate (150 grams of alginate, 1,350 mL water), and 100 grams of glycerin were combined. The components were mixed in a stand mixer or floor mixer.

A mold was then loosely packed with the mixture. The packing amount was based on desired density or thickness of the end material. For 19.05 mm 6.35 mm (0.25 inch) output, the mold was packed to a height of 25.4 mm (1 inch).

A lid of 0.25 inch thickness was then placed on the mold, acting as the male part to compress the material. Using a hydraulic, automatic press, the material was in the mold with 2,000 PSI (2,000 pounds per square inch (PSI) of pressure). The pressure was then released, and the material was removed from the mold.

The material was then placed between two perforated sheets of metal mesh and dried using constant air flow. Once dried, the material was coated by rolling or spraying a 1-2% solution of sodium alginate 1-3 times, creating a water-resistant barrier.

### Example 4

### Preparation of Formed Object(s)

C. sativa stalks (ranging in height from 0.6 m-1.8 m/2 ft-6 ft) were collected and shredded and combined with a 10% alginate solution, as set forth in Example 3. The mixture was combined in a stand mixer or floor mixer. Once combined, the mixture was loosely packed in a mold of desired form or shape. The molds can be metal, 3D printed, silicone, and the like. Optionally, glycerin can be added to the mixture prior to placing it in the mold to create flexible solid materials.

### Example 5

### Preparation of a Thermoplastic Product

Putty, clay like mixture can be prepared by cooking agar, hemp pulp, and glycerin to a temperature of about 86° C. for up to 30 minutes. The process created a rigid, resin-like material that could be spread/injected into molds to create forms.

What is claimed is:

1. A biodegradable composite composition comprising a mixture of:
about 50-95 weight percent (dry solids basis) cannabis or hemp biomass, based on the total weight of the composition; and
about 5-50 weight percent (dry solids basis) binder comprising sodium alginate and vegetable glycerin, wherein the biomass is selected from beaten pulp, shredded stalks, hurd, flower trim, or combinations thereof; and
wherein the composition is selectively formable into flexible films, rigid boards, and three-dimensional molded articles without petroleum-based products.

2. The composition of claim 1, wherein the biomass is obtained from post-harvest cannabis waste, post-extraction cannabis waste, industrial hemp waste, or combinations thereof.

3. The composition of claim 1, wherein the biomass is derived from Cannabis sativa L.

4. The composition of claim 1, wherein the biomass comprises a mixture of two or more biomass types selected from beaten pulp, shredded stalk, hurd, and flower trim in predetermined ratios to tune flexibility or rigidity of the final article.

5. The composition of claim 4, wherein the sodium alginate is food-grade sodium alginate.

6. The composition of claim 1, wherein the sodium alginate and vegetable glycerin function as a dual-component plasticizing and ionic cross-linkable binder system.

7. A flexible biodegradable film formed from the composition of claim 1.

8. A rigid composite board formed from the composition of claim 1.

9. A three-dimensional molded article formed from the composition of claim 1.

10. The article of claim 9, wherein the article is formed by slip-casting the composition into a calcium-containing mold to induce ionic cross-linking of the sodium alginate.

11. The article of claim 10, wherein the calcium-containing mold comprises calcium carbonate plaster.

12. The composition of claim 1, further comprising about 1-25 weight percent water during processing.

13. The flexible film of claim 7, having a thickness of about 0.05-5 mm.

14. The composition of claim 1, wherein the composition is substantially free of petrochemical-derived polymer resins.

15. The composition of claim 1, wherein the resulting article exhibits mechanical strength suitable for packaging, textile, or construction applications.

16. A method of forming a biodegradable composite article comprising:
combining cannabis or hemp biomass with sodium alginate, vegetable glycerin, and water to form a mixture;
shaping the mixture into a mold; and
drying the mixture to form a flexible or rigid article.

17. The method of claim 16, wherein the shaping step comprises slip-casting the mixture into a calcium-containing mold.

18. The method of claim 16, further comprising mechanically reducing the biomass to particle sizes between about 0.02 mm and 127 mm prior to mixing.

19. The composition of claim 1, wherein the composition is capable of biodegrading under aerobic soil or compost conditions without generating persistent microplastics.

20. The article of claim 9, wherein the article is used in packaging, fashion textiles, display materials, construction panels, or decorative objects.
